(19) United States
(12) Patent Application Publication
(10) Pub. No.: US 2011/0255404 A1
(43) Pub. Date: Oct. 20, 2011

(54) System And Method For Data Channel Management

(76) Inventors: Henry J. Kafka, Atlanta, GA (US); Yung Choi-Grogan, Issaquah, WA (US)

(21) Appl. No.: 12/968,542

(22) Filed: Dec. 15, 2010

Related U.S. Application Data
(60) Provisional application No. 61/342,830, filed on Apr. 20, 2010.

(51) Int. Cl. H04L 12/26

(52) U.S. Cl. 370/232

(57) ABSTRACT

In a wireless communications network, a method includes monitoring a data load associated with at least one base station in the network, determining whether a network usage of a subscriber of the network exceeds a threshold and if the subscriber's network usage exceeds the threshold, reducing a data rate available to the subscriber based at least in part on the data load thus monitored.

### CROSS-REFERENCE TO RELATED APPLICATIONS

The subject matter disclosed in this patent application is related to the subject matter disclosed and claimed in U.S. Provisional Patent Application Ser. No. 61/342,830, filed Apr. 20, 2010, the content of which is incorporated by reference herein in its entirety.

### TECHNICAL FIELD

This technical field generally relates to a system and method for throttling data speeds, and more specifically to a system and method for dynamically managing a shared data channel by selectively limiting data speeds in a wireless network.

### BACKGROUND

Data applications have become increasingly important in wireless telecommunications. In addition to data-enabled mobile handsets, there is a proliferation of smartphones such as Apple's iPhone®, the Blackberry® handsets from Research in Motion, and smartphones of other manufacturers including but not limited to Palm, Nokia, Motorola, and High Tech Computer, among others. Such smartphones run on a variety of networks, such as EDGE, GSM, CDMA, 3G and 4G.

In order to take advantage of the features offered by such smartphones and other handsets, carriers have offered and users have elected to purchase unlimited data plans. The problem with such unlimited plans is that there is only a finite amount of bandwidth on the shared data channel. There are certain users that routinely have high data usage and put a strain on the network. There are other times when the volume of users and the aggregate instantaneous load puts a strain on the network. Thus, there is a need in the industry for carriers to be able to dynamically manage the data speed allocated to users.

### SUMMARY

In a wireless communications network, a method is described which includes monitoring a data load associated with at least one base station in the network, determining whether a network usage of a subscriber of the network exceeds a threshold, and if the subscriber's network usage exceeds the threshold, reducing a data rate available to the subscriber based at least in part on the data load thus monitored. The method further includes establishing the threshold prior to the determining step and wherein establishing the threshold comprises looking up a pre-set value or wherein establishing the threshold comprises dynamically adjusting the threshold based on the data load. The method also includes wherein the network is a cellular network and wherein monitoring the data load comprises monitoring of a sector of a cell associated with a base station. There is included a method for adjusting data speeds for a subscriber of mobile communications networks including setting a usage threshold for network usage for the subscriber, monitoring the loading for a sector; and adjusting the data speed of the subscriber downward when the usage threshold is exceeded and based at least in part on the sector load. The method includes the usage threshold being reset periodically. The data speeds of other users in the sector are adjusted downward based on sector load and there may be a different data speed for the subscriber and the other users in the sector regardless of sector loading. The method is implemented by the subscriber priority level being changed from higher priority to lower priority when the usage threshold is met and may be changed by changing a PDP context. The data speed of the subscriber is adjusted to a lower level when the network usage threshold is met and is adjusted further downward based on the sector load.

In a wireless cellular communications network, the description includes a method for controlling data speed including establishing a data speed for a first user of the network, establishing a data speed for a second user of the network, monitoring a network usage of a sector of a cell of the network, and adjusting the data speed of the first user depending on whether a data usage threshold of the first user is exceeded. The method further includes adjusting the data speed of the first user further depending on whether the network usage thus monitored exceeds a loading threshold. The method further includes adjusting the data speed of the second user when one of the loading threshold of the sector and the usage threshold of the second user are met.

The present description is also directed to a system for managing the data speed of a device attached to a network including a network switch including a radio access network, a home location register in communication with the network switch, the home location register configured to store a class of service designation for each subscriber, a serving GPRS support node (SGSN) in communication with the network switch, the SGSN configured to manage the data speed access of the device, and wherein parameters loaded in the radio access network define two priority levels for each subscriber, wherein a first priority level is based on the class of service designation and a second priority level is based on an aggregate data usage parameter and wherein the data rates for the device are based on the first and second priority levels and sector loading as determined by the SGSN.

### BRIEF DESCRIPTION OF THE DRAWINGS

The following description is better understood when read in conjunction with the appended drawings.

FIG. 1 is a simplified functional block diagram of a mobile handset communicating with a radio access network element of a mobile network;

FIG. 2a graphically illustrates the average throughput per subscriber under a sector load scenario in which the heavy user is downgraded based upon the sector load;

FIG. 2b graphically illustrates the average throughput per subscriber under a sector load scenario in which the heavy user is downgraded regardless of the sector load;

FIG. 3 illustrates a flow diagram of an exemplary embodiment;

FIG. 4a graphically illustrates the average throughput per subscriber with no data rate controls;

FIG. 4b graphically illustrates the average throughput per subscriber with the data rate cap control only;

FIG. 4c graphically illustrates the average throughput per subscriber with the THP priority level controls in place;

FIG. 4d graphically illustrates the average throughput per subscriber with both data rate cap and THP priority level controls in place;

FIG. 5 depicts an overall block diagram of an exemplary packet-based mobile cellular network environment, such as a GPRS network

FIG. 6 illustrates an architecture of a typical GPRS network as segmented into four groups; and

FIG. 7 illustrates an example alternate block diagram of an exemplary GSM/GPRS/IP multimedia network architecture.

### DETAILED DESCRIPTION OF ILLUSTRATIVE EMBODIMENTS

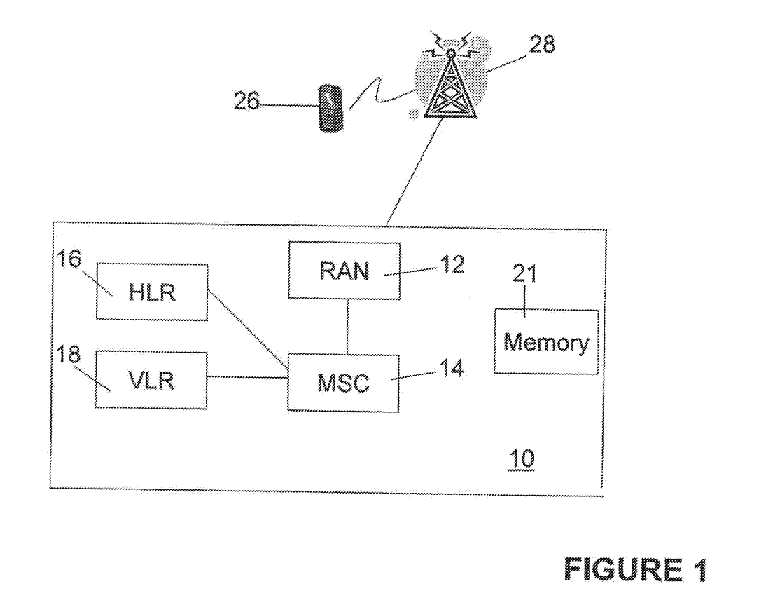

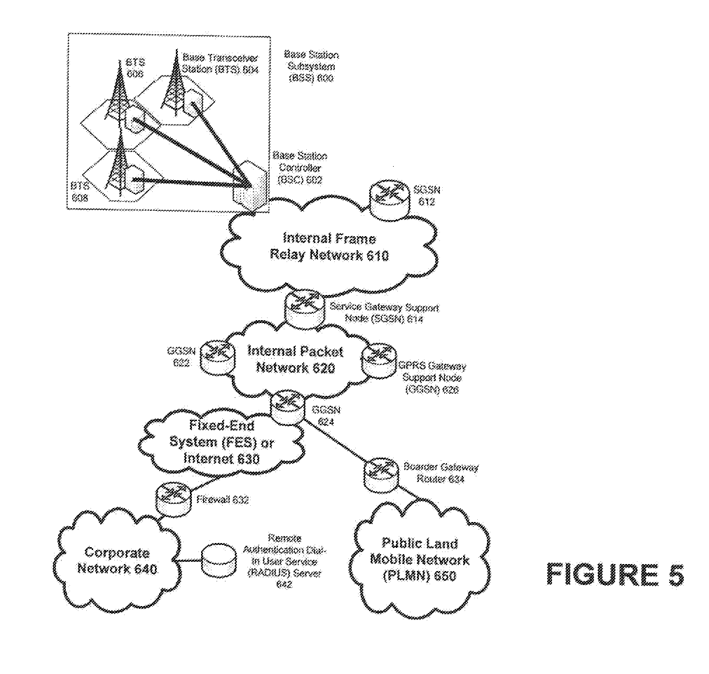

For the purposes of describing an exemplary embodiment, reference will be made to the figures set forth above and appended hereto. With reference to FIG. 1, there is shown a simplified functional block diagram of a wireless network, including mobile switching network equipment 10. The network equipment 10 includes a radio access network (RAN)12, mobile switching center 14, a home location register (HLR) 16 and a visitor location register (VLR) 18. Memory 21 is also shown. More detailed network diagrams are shown in FIGS. 5 through 7 and will be described in greater detail below. Also shown in FIG. 1 is a mobile handset 26 in wireless communication with cellular tower 28 which is in communication with RAN 12.

In data communications using a wireless network, the mobile handset 26 may typically request a certain bit data rate. For example, in a UMTS/HSDPA network, email applications using a mobile handset 26 may use data rates typically ranging from 128 Kbps to 2 Mbps. Web browsing from a mobile handset 26 may use data rates typically ranging from 100 Kbps to 800 Kbps, while certain applications such as YouTube® typically range from 400 Kbps to 800 Kbps. Unless otherwise set forth herein, it is assumed for the examples set forth that all data requests from a mobile device are for data rates of 800 Kbps. However, it will be understood by those skilled in the art that the data rates may vary within a UMTS/HSDPA network and may vary further depending on the type of wireless network, and thus these are non-limiting examples only. It will also be understood that the data rates are nominal only and may vary in real world scenarios based on factors such as topography, the distance of the mobile handset 26 from the cellular tower 28, and other factors.

While the description will be with reference to mobile handsets 26, it will be understood by those skilled in the art that the description applies to data access though mobile handsets, PDA's, smartphones, network computers using cellular wireless data cards and other devices capable of wireless data communications. There are two exemplary processes embodied in the description which enable a network carrier to throttle data rates, namely priority settings for individual users and speed caps for sectors experiencing data traffic congestion.

Wireless network systems may include traffic handling priority (THP) settings having levels which may, for example, be designated as THP levels 1, 2, 3. For illustrative purposes only, THP level 3 (also designated herein as THP3) will be considered the lowest priority level, with THP level 2 (also designated herein as THP2) being the medium priority level and THP level 1 (also designated herein as THP3) being the highest priority. It will be understood that the description is not limited thereby and the network equipment utilized for implementation may include more or less than three priority levels and may have different naming conventions associated therewith. For example, there may be other QoS classes, such as Allocation Retention Priority levels, Conversational, Streaming and background classes. Thus there may be multiple levels of priorities. Such priorities could tailor to specific applications such as PDP context.

The THP settings may be designated as a quality of service setting in a HLR 16. A scheduling algorithm in the RAN 12 (Node B) may set the priorities in such a way so that THP2 users will receive more resources that THP3 users as THP3 users will be spread further in time in the scheduling queue that THP2 users. THP1 may be reserved for special functionality or program priorities. THP1 users typically will be afforded even more resources and higher data rates than THP2 users. The data rates will be such that THP3 users will still enjoy a high enough data rate for operational satisfaction and may, for example, have minimum data rate speeds set at EDGE levels of 128 Kbps.

In accordance with an embodiment, the THP setting may be varied for individual users. For example, the THP setting may be changed from THP2 to THP3 when a user reaches a certain aggregate data threshold during a time period. The aggregate data threshold may, for example, be 2 GB during a time period specified as a single billing cycle. An individual user meeting that threshold may have his or her THP set to the lower priority for the duration of the billing cycle, with the aggregate data usage being reset to zero at the start of the next billing cycle. It is possible that some heavy users would meet the threshold early in the billing cycle, while others will meet the threshold later in the billing cycle and while still others will never meet that threshold in any billing cycle.

It will be understood by those skilled in the art that the scheduling algorithms may differ based on the manufacturer of the equipment. For example, Ericsson and Alcatel Lucent manufacture RAN equipment 12 for a UMTS/HSDPA network. For an Ericsson-manufactured RAN, the THP levels may be set using feature activation and setting Node B level scheduling weight parameters for THP2 and THP3 levels, and then activating the THP level HSDPA counters. Exemplary values for Node B level parameters for the downlink and uplink for THP2 and THP3 may be as follows: the value “schprioforabsressnaring” may be 15 and the value for “Queusselectionalogrithm” may be “Pf-1” while the value for “schweight” may be 400 for THP2 and 200 for THP3. For an Alcatel-Lucent manufactured RAN, there is no feature activation. Node B level parameters for the scheduling algorithm for a THP2 downlink may be K-factor=7, B-factor=7, Rmin=100 kbps and Rmax=1500 kbps. For THP3 downlink, the Node B level parameters may be K-factor=5, B-factor=5, Rmin=40 kbps and Rmax=150 kbps. For the THP2 uplink, the Node B parameters may be K-factor=7, B-factor=7, Rmin=100 kbps and Rmax=800 kbps. For THP3 downlink, the Node B level parameters may be K-factor=5, B-factor=5, Rmin=40 kbps and Rmax=150 kbps.

Notwithstanding the throttling of data rates for certain heavy users, there may also be congestion caused by too many users in a given sector within a cell. To address this, speed caps or data rate caps may be placed on some or all users with a given section. As such, an exemplary embodiment also includes implementing speed caps or data rate caps on all users within a given sector under heavy load conditions regardless of the respective priority levels of the users.

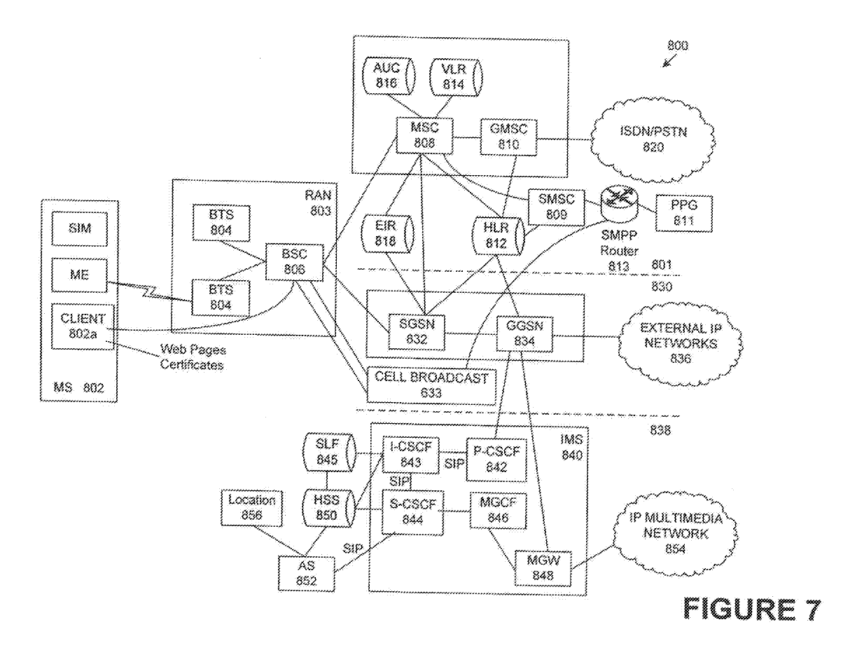

In any given sector, the capacity for the network to deliver data services is finite. Data rate caps, also referred to as speed caps herein, may be implemented under various loading conditions. In one embodiment, the speed caps may be implemented gradually as new users enter a sector. Alternatively, the speed caps may be implemented as a step function or in any other relationship wherein the average speed per user decreases as the number of users in a sector increase. Speed caps may be implemented by setting parameters in the SGSN 832 in FIG. 7.

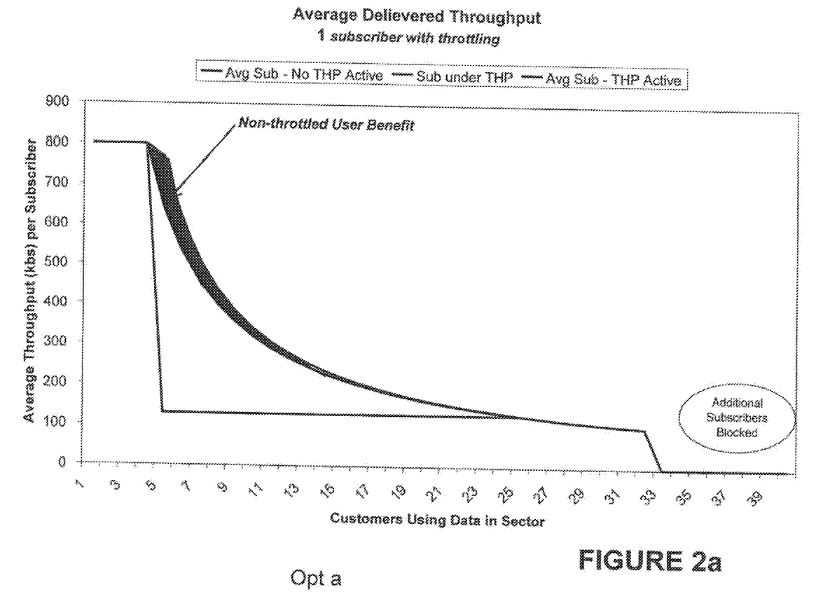

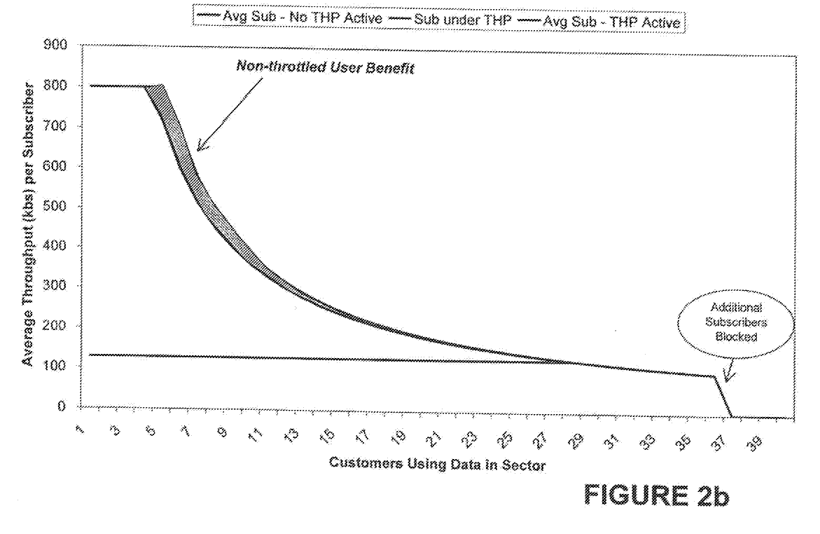

For the purpose of an example, it is assumed that there are two UMTS carriers per sector each dedicated 50% to voice thus providing approximately 3.6 Mbps for data per sector. Total capacity normally varies by approximately 30% based on user radio conditions (e.g. user at cell edge). It is also assumed that the wireless carrier desires to reduce a managed customer to 128 Kbps when the 2 GB threshold has been exceeded and the “trigger rules” are present. Finally, it is assumed that a sector will cease to accept new device requests when every device is managed down to 100 Kbps (i.e., requests are blocked at some point). In accordance with one embodiment, the trigger rules are such that the THP level may be downgraded for a user upon the combination of a predetermined aggregate data threshold being met by a user and a threshold of overall sector loading being met. In accordance with an alternative embodiment, the trigger rules are such that the THP level may be downgraded for a user when the predetermined aggregate data threshold is met, regardless of sector loading. FIGS. 2a and 2b, respectively, illustrate exemplary data throughputs in each of those scenarios.

In addition to setting the data rates or data management levels based on sector loading or the aggregate data thresholds, data rates may be determined on an application by application basis, wherein higher priority applications may have a higher data rate and a lower priority application may have a lower data rate. The data rates may also be adjusted based on a combination of any two of sector loading, aggregate data thresholds and application priority levels.

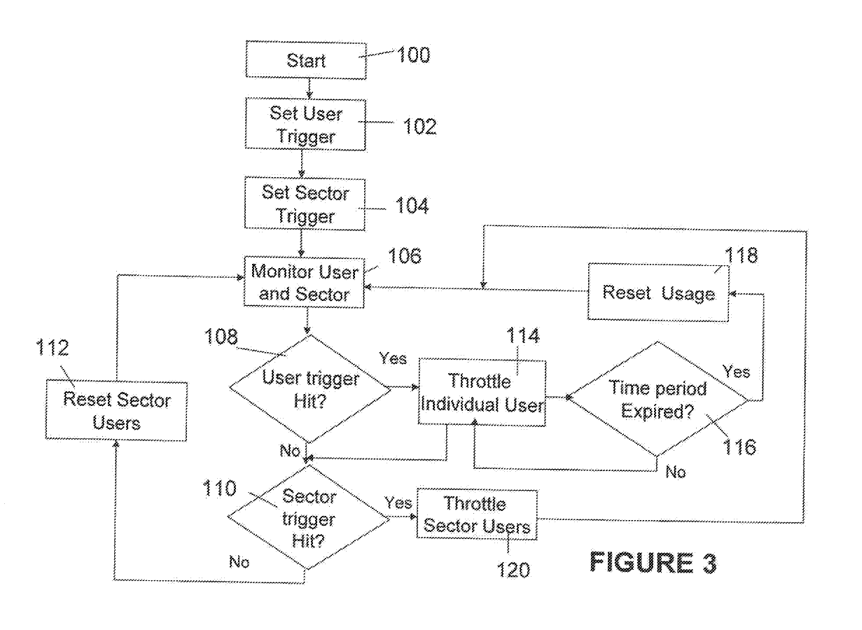

FIG. 3 is a flow chart describing an embodiment of a method. The process starts at 100. At 102, the network operator sets the user trigger specifying a threshold on the aggregate data size a user is entitled to at the highest THP priority level during a billing cycle, which upper limit may, for example, be 2 GB. At 104, the network operator sets a sector trigger specifying the aggregate data demand in a particular sector before speed caps are put in place on all users in that sector. At 106, the network operator monitors the total usage of all individual subscribers during a billing cycle and the load on each individual sector. At 108, the decision point is hit as to whether an individual subscriber has met the aggregate threshold put in place for that subscriber for that billing cycle. If yes, the process continues at 114 where the maximum data rate for the individual subscriber hitting that threshold is decreased for the remainder of the billing cycle. The process continually monitors the billing cycle or other time period in 116 and if the billing cycle or other time period has not expired, throttling for the individual subscriber continues at 114. If the billing cycle or time period has expired, the usage counter for that subscriber is reset at 118 and the monitoring process continues at 106.

Continuing with the other leg of the flow diagram at 108, if the user trigger is not met at 108 or it has been met and the user is throttled at 114, another decision block at 110 is encountered. That decision is whether the sector trigger for overall loading has been met. If yes, all users in the sector are throttled with a speed cap at 120 and the monitoring process continues at 106. If the sector does not meet the threshold or falls below the threshold at 110, the sector data rates are reset at 112 and the monitoring of the users and sectors continues at 106.

There are various methodologies that may be employed by a network operator to dynamically manage down assigned data rates. One method is for subscribers exceeding 2 GB (during a billing cycle) within a sector to be managed down only when that sector is experiencing congestion. Using that method, there will be a significant differential in data rates between managed customers and the remainder of the base only during periods of sector congestion. Another method is managing down maximum data rates for subscribers exceeding a threshold within a billing cycle, (e.g., 2 GB per month) in all sectors at all times after the 2 GB trigger point regardless of sector loading.

A combination of the two approaches may be employed, that is, initiating a speed cap based on usage thresholds above the minimum acceptable data rate level and then reducing the data rate to the minimum acceptable level based on sector loading. For example, a carrier may establish a speed cap of 400 Kbps for those managed subscribers regardless of sector congestion status and then gradually reduce that to 128 Kbps for those managed subscribers under heavy congestion. Thus, the carrier may maintain a data rate preference for non-managed subscribers at congested locations and may, in fact, be able to maintain differentiation between managed and non-managed subscribers at all levels of sector utilization.

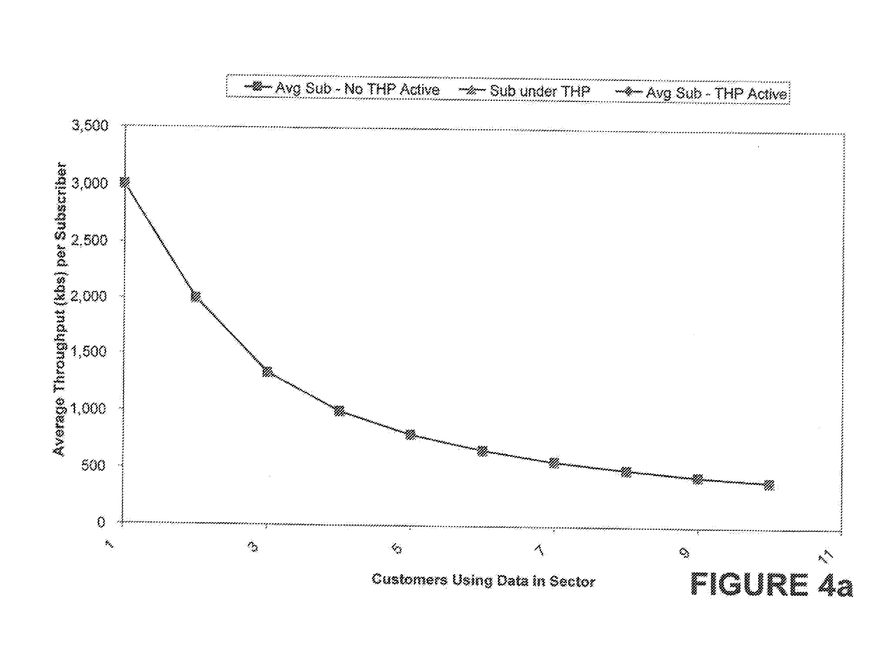

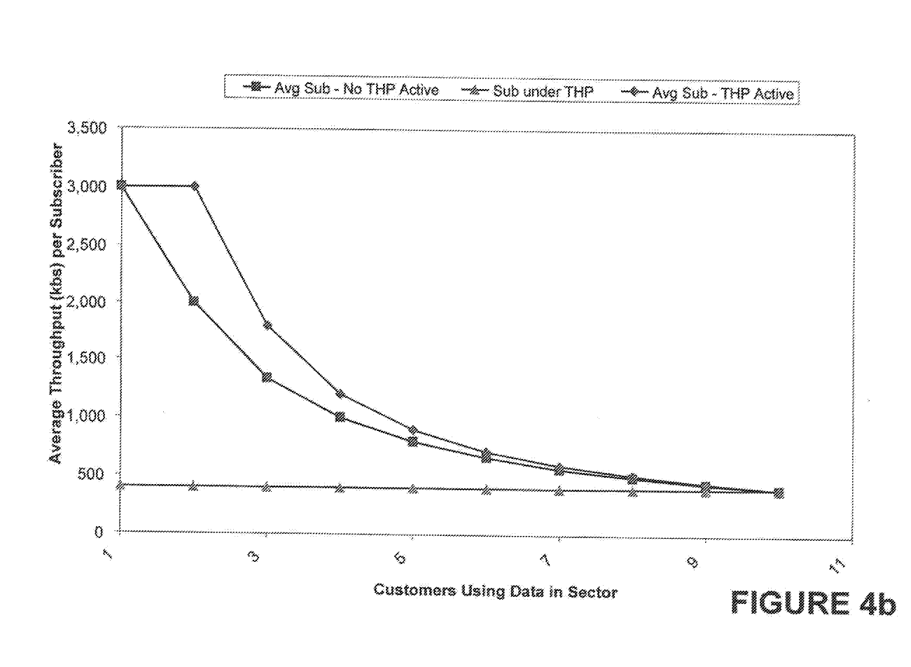

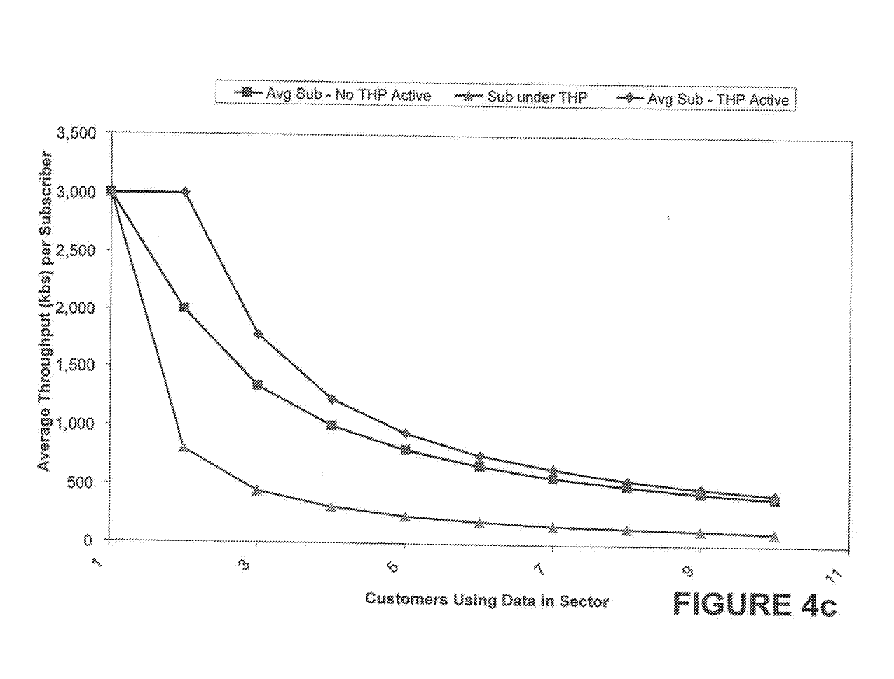

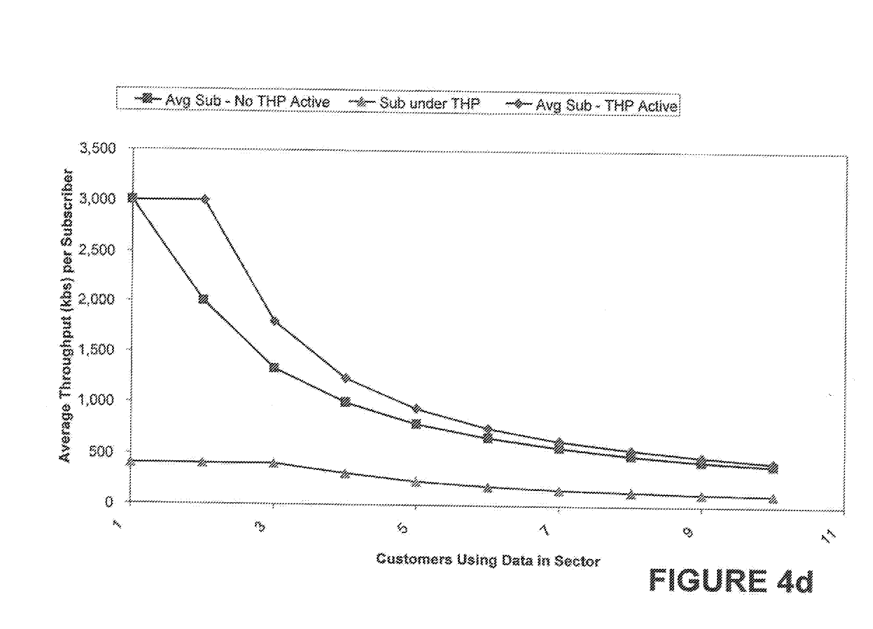

With respect to FIGS. 4a to 4d, there are shown graphical representations of loading under certain conditions. As the number of subscribers in a sector increase, the average data bit rate decreases. In FIG. 4a with no controls, each customer in the sector has the same nominal data rate. In FIG. 4b with a speed cap in place with a single subscriber under the lower priority THP level, the subscriber under the lower priority THP level is shown as a constant, while the other subscribers in a sector are subject to a data rate decrease as the sector becomes more loaded. In this scenario under heavy loads, there is a point where virtually no difference in data rates exist between the lower THP priority subscriber and all other subscribers. In FIG. 4c with a THP level in place but no speed cap, the subscriber that is under the lower priority THP level and is in the sector alone has the same data speed as other users would have if those other users were alone in the sector. As the sector is subject to an increased load, the differences between the lower priority THP level subscriber and all other subscribers diminishes but is never equal to zero. Finally, FIG. 4d graphically illustrates the average throughput per subscriber with both data rate cap and THP priority level controls in place. It can be seen that the data rate level for the lower priority THP level subscriber is significantly less that that for other users in the sector under light loading conditions and at least some difference in data rate levels between the two groups is maintained under heavy loads.

In implementation, each of the PDP context names that are used in establishing a data session may be given a name that is associated with the throttling parameters. For example, for a given subscriber, PDP Name1 may be associated with THP2 and the speed cap and PDP Name2 may be associated with THP3 and the speed cap. When that subscriber meets the monthly aggregate data threshold, the subscriber is switched from PDP Name1 to PDP Name2. At the conclusion of the time period, data usage is reset and that subscriber is switched back to PDP Name2.

There are other variations of the throttling parameters that may be implemented in various embodiments. In one embodiment, applications running on a mobile handset may be given different data rate caps based on priority of the application. For example, a real time application such as video streaming may be given a higher priority and thus a higher data rate than a non-real time application. The applications may also be further distinguished by each subscriber and further by sector loading such that a high priority application for one user may be allocated a higher data rate than the same application for a second user, and both may be throttled lower based on sector loading.

The following description sets forth some exemplary telephony radio networks and non-limiting operating environments in which predetermined emergency alert messages can be implemented. The below-described operating environments should be considered non-exhaustive, however, and thus the below-described network architectures merely show how predetermined emergency alert messages can be incorporated into existing network structures and architectures. It can be appreciated, however, that predetermined emergency alert messages can be incorporated into existing and/or future alternative architectures for communication networks as well.

The global system for mobile communication (“GSM”) is one of the most widely utilized wireless access systems in today's fast growing communication environment. The GSM provides circuit-switched data services to subscribers, such as mobile telephone or computer users. The General Packet Radio Service (“GPRS”), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that become available in time. In this regard, the techniques of EAS channel assignment can be applied independently of the method for data transport, and do not depend on any particular network architecture, or underlying protocols.

FIG. 5 depicts an overall block diagram of an exemplary packet-based mobile cellular network environment, such as a GPRS network, in which the system for implementing predetermined emergency alert messages can be practiced. In an example configuration, the cellular radio network 34 and towers 36 are encompassed by the network environment depicted in FIG. 5. In such an environment, there are a plurality of Base Station Subsystems (“BSS”) 600 (only one is shown), each of which comprises a Base Station Controller (“BSC”) 602 serving a plurality of Base Transceiver Stations (“BTS”) such as BTSs 604, 606, and 608. BTSs 604, 606, 608, etc. are the access points where users of packet-based mobile devices (e.g., mobile device 12) become connected to the wireless network. In exemplary fashion, the packet traffic originating from user devices (e.g., user device 60) is transported via an over-the-air interface to a BTS 608, and from the BTS 608 to the BSC 602. Base station subsystems, such as BSS 600, are a part of internal frame relay network 610 that can include Service GPRS Support Nodes (“SGSN”) such as SGSN 612 and 614. Each SGSN is connected to an internal packet network 620 through which a SGSN 612, 614, etc. can route data packets to and from a plurality of gateway GPRS support nodes (GGSN) 622, 624, 626, etc. As illustrated, SGSN 614 and GGSNs 622, 624, and 626 are part of internal packet network 620. Gateway GPRS serving nodes 622, 624 and 626 mainly provide an interface to external Internet Protocol (“IP”) networks such as Public Land Mobile Network (“PLMN”) 650, corporate intranets 640, or Fixed-End System (“FES”) or the public Internet 630. As illustrated, subscriber corporate network 640 may be connected to GGSN 624 via firewall 632; and PLMN 650 is connected to GGSN 624 via border gateway router 634. The Remote Authentication Dial-In User Service (“RADIUS”) server 642 may be used for caller authentication when a user of a mobile cellular device calls corporate network 640.

Generally, there can be four different cell sizes in a GSM network, referred to as macro, micro, pico, and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. On the other hand, umbrella cells are used to cover shadowed regions of smaller cells and fill in gaps in coverage between those cells.

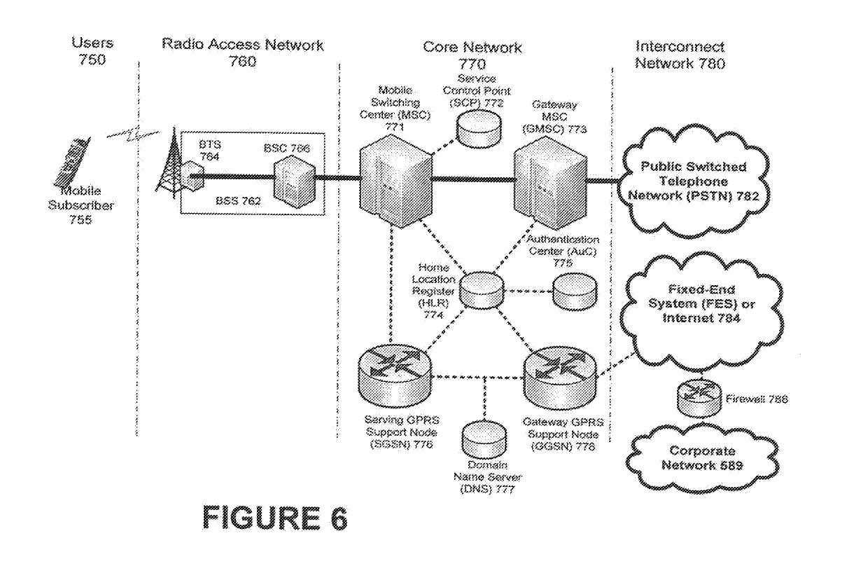

FIG. 6 illustrates an architecture of a typical GPRS network as segmented into four groups: users 750, radio access network 760, core network 770, and interconnect network 780. In an example configuration the emergency alert network 110, and the wireless broadcast network 116 are encompassed by the radio access network 760, core network 770, and interconnect network 780. Users 750 comprise a plurality of end users (though only mobile subscriber 755 is shown in FIG. 6). In an example embodiment, the device depicted as mobile subscriber 755 comprises mobile device 12. Radio access network 760 comprises a plurality of base station subsystems such as BSSs 762, which include BTSs 764 and BSCs 766. Core network 770 comprises a host of various network elements. As illustrated here, core network 770 may comprise Mobile Switching Center (“MSC”) 771, Service Control Point (“SCP”) 772, gateway MSC 773, SGSN 776, Home Location Register (“HLR”) 774, Authentication Center (“AuC”) 775, Domain Name Server (“DNS”) 777, and GGSN 778. Interconnect network 780 also comprises a host of various networks and other network elements. As illustrated in FIG. 6, interconnect network 780 comprises Public Switched Telephone Network (“PSTN”) 782, Fixed-End System (“FES”) or Internet 784, firewall 788, and Corporate Network 789.

A mobile switching center can be connected to a large number of base station controllers. At MSC 771, for instance, depending on the type of traffic, the traffic may be separated in that voice may be sent to Public Switched Telephone Network (“PSTN”) 782 through Gateway MSC (“GMSC”) 773, and/or data may be sent to SGSN 776, which then sends the data traffic to GGSN 778 for further forwarding.

When MSC 771 receives call traffic, for example, from BSC 766, it sends a query to a database hosted by SCP 772. The SCP 772 processes the request and issues a response to MSC 771 so that it may continue call processing as appropriate.

The HLR 774 is a centralized database for users to register to the GPRS network. HLR 774 stores static information about the subscribers such as the International Mobile Subscriber Identity (“IMSI”), subscribed services, and a key for authenticating the subscriber. HLR 774 also stores dynamic subscriber information such as the current location of the mobile subscriber. Associated with HLR 774 is AuC 775. AuC 775 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as the mobile device 12, used by an end user of the mobile cellular service. When a mobile subscriber turns on his or her mobile device, the mobile device goes through an attach process by which the mobile device attaches to an SGSN of the GPRS network. In FIG. 6, when mobile subscriber 755 initiates the attach process by turning on the network capabilities of the mobile device, an attach request is sent by mobile subscriber 755 to SGSN 776. The SGSN 776 queries another SGSN, to which mobile subscriber 755 was attached before, for the identity of mobile subscriber 755. Upon receiving the identity of mobile subscriber 755 from the other SGSN, SGSN 776 requests more information from mobile subscriber 755. This information is used to authenticate mobile subscriber 755 to SGSN 776 by HLR 774. Once verified, SGSN 776 sends a location update to HLR 774 indicating the change of location to a new SGSN, in this case SGSN 776. HLR 774 notifies the old SGSN, to which mobile subscriber 755 was attached before, to cancel the location process for mobile subscriber 755. HLR 774 then notifies SGSN 776 that the location update has been performed. At this time, SGSN 776 sends an Attach Accept message to mobile subscriber 755, which in turn sends an Attach Complete message to SGSN 776.

After attaching itself with the network, mobile subscriber 755 then goes through the authentication process. In the authentication process, SGSN 776 sends the authentication information to HLR 774, which sends information back to SGSN 776 based on the user profile that was part of the user's initial setup. The SGSN 776 then sends a request for authentication and ciphering to mobile subscriber 755. The mobile subscriber 755 uses an algorithm to send the user identification (ID) and password to SGSN 776. The SGSN 776 uses the same algorithm and compares the result. If a match occurs, SGSN 776 authenticates mobile subscriber 755.

Next, the mobile subscriber 755 establishes a user session with the destination network, corporate network 789, by going through a Packet Data Protocol (“PDP”) activation process. Briefly, in the process, mobile subscriber 755 requests access to the Access Point Name (“APN”), for example, UPS.com (e.g., which can be corporate network 789 in FIG. 6) and SGSN 776 receives the activation request from mobile subscriber 755. SGSN 776 then initiates a Domain Name Service (“DNS”) query to learn which GGSN node has access to the UPS.com APN. The DNS query is sent to the DNS server within the core network 770, such as DNS 777, which is provisioned to map to one or more GGSN nodes in the core network 770. Based on the APN, the mapped GGSN 778 can access the requested corporate network 789. The SGSN 776 then sends to GGSN 778 a Create Packet Data Protocol (“PDP”) Context Request message that contains necessary information. The GGSN 778 sends a Create PDP Context Response message to SGSN 776, which then sends an Activate PDP Context Accept message to mobile subscriber 755.

Once activated, data packets of the call made by mobile subscriber 755 can then go through radio access network 760, core network 770, and interconnect network 780, in a particular fixed-end system or Internet 784 and firewall 788, to reach corporate network 789.

Thus, network elements that can invoke the functionality of predetermined emergency alert messages can include but are not limited to Gateway GPRS Support Node tables, Fixed End System router tables, firewall systems, VPN tunnels, and any number of other network elements as required by the particular digital network.

FIG. 7 illustrates another exemplary block diagram view of a GSM/GPRS/IP multimedia network architecture 800 in which predetermined emergency alert messages can be incorporated. As illustrated, architecture 800 of FIG. 7 includes a GSM core network 801, a GPRS network 830 and an IP multimedia network 838. The GSM core network 801 includes a Mobile Station (MS) 802, at least one Base Transceiver Station (BTS) 804 and a Base Station Controller (BSC) 806. The MS 802 is physical equipment or Mobile Equipment (ME), such as a mobile phone or a laptop computer (e.g., mobile device 12) that is used by mobile subscribers, with a Subscriber identity Module (SIM). The SIM includes an International Mobile Subscriber Identity (IMSI), which is a unique identifier of a subscriber. The BTS 804 is physical equipment, such as a radio tower, that enables a radio interface to communicate with the MS. Each BTS may serve more than one MS. The BSC 806 manages radio resources, including the BTS. The BSC may be connected to several BTSs. The BSC and BTS components, in combination, are generally referred to as a base station (BSS) or radio access network (RAN) 803.

The GSM core network 801 also includes a Mobile Switching Center (MSC) 808, a Gateway Mobile Switching Center (GMSC) 810, a Home Location Register (HLR) 812, Visitor Location Register (VLR) 814, an Authentication Center (AuC) 818, and an Equipment Identity Register (EIR) 816. The MSC 808 performs a switching function for the network. The MSC also performs other functions, such as registration, authentication, location updating, handovers, and call routing. The GMSC 810 provides a gateway between the GSM network and other networks, such as an Integrated Services Digital Network (ISDN) or Public Switched Telephone Networks (PSTNs) 820. Thus, the GMSC 810 provides interworking functionality with external networks.

The HLR 812 is a database that contains administrative information regarding each subscriber registered in a corresponding GSM network. The HLR 812 also contains the current location of each MS. The VLR 814 is a database that contains selected administrative information from the HLR 812. The VLR contains information necessary for call control and provision of subscribed services for each MS currently located in a geographical area controlled by the VLR. The HLR 812 and the VLR 814, together with the MSC 808, provide the call routing and roaming capabilities of GSM. The AuC 816 provides the parameters needed for authentication and encryption functions. Such parameters allow verification of a subscriber's identity. The EIR 818 stores security-sensitive information about the mobile equipment.

A Short Message Service Center (SMSC) 809 allows one-to-one Short Message Service (SMS) messages to be sent to/from the MS 802. A Push Proxy Gateway (PPG) 811 is used to “push” (i.e., send without a synchronous request) content to the MS 802. The PPG 811 acts as a proxy between wired and wireless networks to facilitate pushing of data to the MS 802. A Short Message Peer to Peer (SMPP) protocol router 813 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 802 sends a location update including its current location information to the MSC/VLR, via the BTS 804 and the BSC 806. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 830 is logically implemented on the GSM core network architecture by introducing two packet-switching network nodes, a serving GPRS support node (SGSN) 832, a cell broadcast and a Gateway GPRS support node (GGSN) 834. The SGSN 832 is at the same hierarchical level as the MSC 808 in the GSM network. The SGSN controls the connection between the GPRS network and the MS 802. The SGSN also keeps track of individual MS's locations and security functions and access controls.

A Cell Broadcast Center (CBC) 833 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 834 provides a gateway between the GPRS network and a public packet network (PDN) or other IP networks 836. That is, the GGSN provides interworking functionality with external networks, and sets up a logical link to the MS through the SGSN. When packet-switched data leaves the GPRS network, it is transferred to an external TCP-IP network 836, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 830 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

The IP multimedia network 838 was introduced with 3GPP Release 5, and includes an IP multimedia subsystem (IMS) 840 to provide rich multimedia services to end users. A representative set of the network entities within the IMS 840 are a call/session control function (CSCF), a media gateway control function (MGCF) 846, a media gateway (MGW) 848, and a master subscriber database, called a home subscriber server (HSS) 850. The HSS 850 may be common to the GSM network 801, the GPRS network 830 as well as the IP multimedia network 838.

The IP multimedia system 840 is built around the call/session control function, of which there are three types: an interrogating CSCF (I-CSCF) 843, a proxy CSCF (P-CSCF) 842, and a serving CSCF (S-CSCF) 844. The P-CSCF 842 is the MS's first point of contact with the IMS 840. The P-CSCF 842 forwards session initiation protocol (SIP) messages received from the MS to an SIP server in a home network (and vice versa) of the MS. The P-CSCF 842 may also modify an outgoing request according to a set of rules defined by the network operator (for example, address analysis and potential modification).

The I-CSCF 843, forms an entrance to a home network and hides the inner topology of the home network from other networks and provides flexibility for selecting an S-CSCF. The I-CSCF 843 may contact a subscriber location function (SLF) 845 to determine which HSS 850 to use for the particular subscriber, if multiple HSS's 850 are present. The S-CSCF 844 performs the session control services for the MS 802. This includes routing originating sessions to external networks and routing terminating sessions to visited networks. The S-CSCF 844 also decides whether an application server (AS) 852 is required to receive information on an incoming SIP session request to ensure appropriate service handling. This decision is based on information received from the HSS 850 (or other sources, such as an application server 852). The AS 852 also communicates to a location server 856 (e.g., a Gateway Mobile Location Center (GMLC)) that provides a position (e.g., latitude/longitude coordinates) of the MS 802.

The HSS 850 contains a subscriber profile and keeps track of which core network node is currently handling the subscriber. It also supports subscriber authentication and authorization functions (AAA). In networks with more than one HSS 850, a subscriber location function provides information on the HSS 850 that contains the profile of a given subscriber.

The MGCF 846 provides interworking functionality between SIP session control signaling from the IMS 840 and ISUP/BICC call control signaling from the external GSTN networks (not shown). It also controls the media gateway (MGW) 848 that provides user-plane interworking functionality (e.g., converting between AMR- and PCM-coded voice). The MGW 848 also communicates with other IP multimedia networks 854.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of managed data channels have been described in connection with various computing devices, the underlying concepts can be applied to any computing device or system capable of access wireless data networks. The various techniques described herein can be implemented in connection with hardware or software or, where appropriate, with a combination of both. Thus, the methods and apparatus for managing data rates in mobile networks, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing predetermined emergency alert messages. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

While the description is consistent with the various embodiments of the various figures, it is to be understood that other similar embodiments can be used or modifications and additions can be made to the described embodiment for performing the same function without deviating therefrom. For example, threshold parameters may be fixed or preset, or they may be adjusted dynamically based on factors such as time of day, expected loading, subscriber forecasts, or any other such criteria. Adjusting the data rates of subscribers exceeding the allotted threshold may be accomplished by switching that subscriber to a slower network or switching that subscriber to an alternative frequency spectrum and thereby effectively reducing the data rate of the subscriber. Therefore, the method and system should not be limited to any single embodiment, but rather should be construed in breadth and scope in accordance with the appended claims.

What is claimed:

1. In a wireless communications network, a method comprising:
monitoring a data load associated with at least one base station in the network;
determining whether a network usage of a subscriber of the network exceeds a threshold;
if the subscriber's network usage exceeds the threshold, reducing a data rate available to the subscriber based at least in part on the data load thus monitored.

2. The method of claim 1 further comprising establishing the threshold prior to the determining step.

3. The method of claim 2 wherein establishing the threshold comprises looking up a pre-set value.

4. The method of claim 2 wherein establishing the threshold comprises dynamically adjusting the threshold based on the data load.

5. The method of claim 1 wherein the network is a cellular network and wherein monitoring the data load comprises monitoring of a sector of a cell associated with a base station.

6. The method of claim 1 wherein the threshold is reset periodically.

7. The method of claim 1 wherein the data speeds of other users in the sector are reduced based on sector load.

8. The method of claim 1 wherein there is a different data speed for the subscriber and the other users in the sector regardless of sector loading.

9. The method of claim 1 wherein the subscriber priority level is changed from higher priority to lower priority when the usage threshold is met.

10. The method of claim 9 wherein the priority level is changed by changing a PDP context.

11. The method of claim 1 wherein the data speed of the subscriber is adjusted to a lower level when the network usage threshold is met and is adjusted further downward based on the sector load.

12. The method of claim 1 wherein the data speed of the subscriber is adjusted upward upon expiration of a time period.

13. In a wireless cellular communications network, a method for controlling data speed comprising:
establishing a data speed for a first user of the network;
establishing a data speed for a second user of the network;
monitoring a network usage of a sector of a cell of the network; and
adjusting the data speed of the first user depending on whether a data usage threshold of the first user is exceeded.

14. The method of claim 13 comprising adjusting the data speed of the first user further depending on whether the network usage thus monitored exceeds a loading threshold.

15. The method of claim 13 comprising adjusting the data speed of the second user when one of the loading threshold of the sector and the usage threshold of the second user are met.

16. The method of claim 13 further comprising adjusting the data speed of the first user upward after a time period.

17. The method of claim 13 wherein adjusting the data speed comprises adjusting the priority level.

18. The method of claim 13 wherein adjusting the data speed comprises initiating a speed cap.

19. A system for managing the data speed of a device attached to a network, comprising:
a network switch including a radio access network;
a home location register in communication with the network switch, the home location register configured to store a class of service designation for each subscriber;
a serving GPRS support node (SGSN) in communication with the network switch, the SGSN configured to manage the data speed access of the device; and
wherein parameters loaded in the radio access network define two data management levels for each subscriber, wherein a first data management level is based on the class of service designation and a second data management level is based on an aggregate data usage parameter and wherein the data rates for the device are based on the first and second data management level and sector loading as determined by the SGSN.

20. A method of determining data rates for a subscriber in a network, comprising:
setting a priority level for applications running on a device in data communications with the network; and
establishing a data rate for each application based on the priority level.

21. The method of claim 20 further comprising measuring the data load associated with the network and wherein the data rate for at least one application is adjusted based on the data load exceeding a threshold.

22. The method of claim 21 further comprising measuring the aggregate network usage of the subscriber during a time period and the data rates are further adjusted based on one of the data load and the network usage exceeding a threshold.

23. The method of claim 20 further comprising measuring the network usage of the subscriber and adjusting the data rates for each application if the aggregate network usage of the subscriber exceeds a threshold during a predetermined time period.

24. The method of claim 23 wherein the data rates are re-adjusted after the predetermined time period has elapsed

25. The method of claim 20 further comprising determining data rates for a second subscriber, including setting a priority level for applications running on a second device in data communications with the network; and
establishing a data rate for each application running on the second device based on the priority level.

26. The method of claim 25 further comprising measuring the data load associated with the network and wherein the data rate for at least one application on the device or one application on the second device is adjusted based on the data load.

27. The method of claim 25 further comprising measuring the aggregate data usage of the subscriber and the second subscriber and adjusting the data rate for at least one application on the device if the aggregate data usage of the subscriber exceeds a threshold and adjusting the data rate for at least one application on the second device if the aggregate data usage of the second subscriber exceeds a threshold.
